(19) United States
(12) Patent Application Publication
(10) Pub. No.: US 2011/0240761 A1
(43) Pub. Date: Oct. 6, 2011

(54) ROOF MOUNTED SPRINKLERS

(76) Inventor: Harvey Kornhaber, Truckee, CA (US)

(21) Appl. No.: 13/075,267

(22) Filed: Mar. 30, 2011

Related U.S. Application Data
(60) Provisional application No. 61/320,411, filed on Apr. 2, 2010.

(51) Int. Cl. B05B 15/06; B23P 19/00

(52) U.S. Cl. 239/208; 29/428

(57) ABSTRACT

A sprinkler system includes a base having a watertight backing material, adapted to attach to a roof; a sprinkler head attached to the base; a coupling adapted to attach a water hose to the sprinkler head; a securing mechanism adapted to attach the sprinkler to the roof; and a cover to protect the sprinkler head when the sprinkler is not in use. The sprinkler may be adjusted directionally to have a directional stream or spray of water of varying degrees of 360 degree coverage.

### RELATED APPLICATIONS

This application claims the benefit of the filing date of U.S. patent application Ser. No. 61/320,411, filed Apr. 2, 2010, which is incorporated herein by reference in its entirety.

### BACKGROUND OF THE INVENTION

The present invention generally relates to watering systems and more specifically to roof mounted sprinklers.

Current systems are attached to water supplies requiring plumbing, professionally installed and very expensive, usually only done on new construction, if at all.

It would be desirable to have sprinklers, unattached to hoses until needed, to protect a home from nearby forest fires.

### SUMMARY OF THE INVENTION

In one aspect of the present invention, a sprinkler utilizing a roof and a water hose includes a base; a sprinkler head attached to the base; a coupling adapted to attach the water hose to the sprinkler head; a securing mechanism adapted to attach the sprinkler to the roof; and a cover to protect the sprinkler head when the sprinkler is not in use.

In another aspect of the present invention, a sprinkler system includes a base having a watertight backing material, adapted to attach to a roof; a sprinkler head attached to the base; a coupling adapted to attach a water hose to the sprinkler head; a securing mechanism adapted to attach the sprinkler to the roof; and a cover to protect the sprinkler head when the sprinkler is not in use.

In yet another aspect of the present invention, a method of protecting a roof with a water hose includes providing a base; attaching a sprinkler head to the base; attaching a water hose to the sprinkler head; securing the water hose to the sprinkler head utilizing a securing mechanism; covering the sprinkler head with a cover when the sprinkler is not in use; and uncovering the sprinkler head and utilizing the water hose to protect the roof.

### BRIEF DESCRIPTION OF THE DRAWINGS

FIG. 1 is a perspective view of an embodiment of the present invention in use;

FIG. 2 is a perspective view of the embodiment of FIG. 1;

FIG. 3 is a perspective view of an alternate embodiment of the embodiment of FIG. 1;

FIG. 4 is an exploded perspective view of the embodiment of FIG. 1; and

FIG. 5 is a section view of the embodiment of FIG. 1 taken along line 5-5.

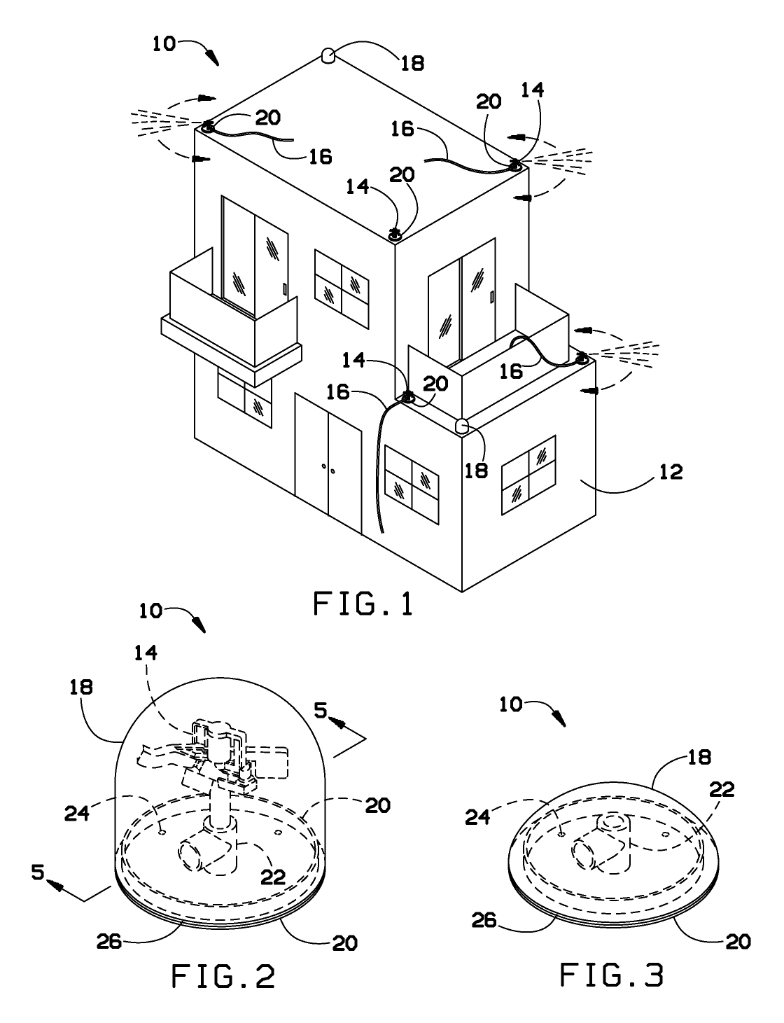

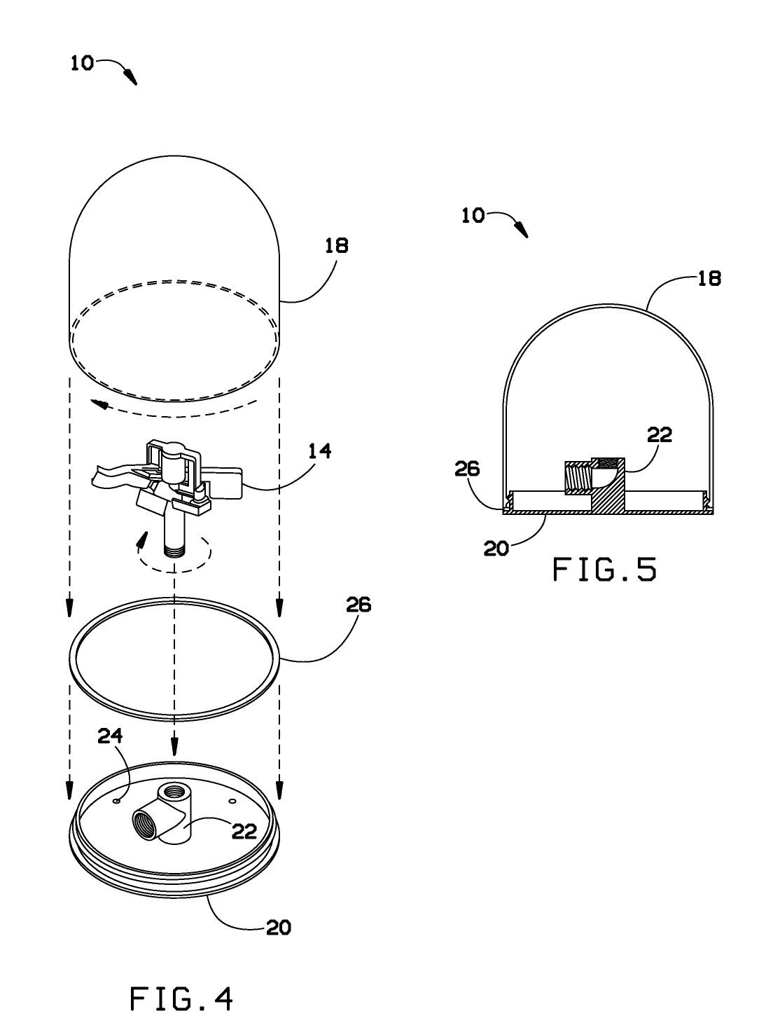

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides roof mounted—sprinkler head supports, unattached to hoses until needed, to protect a home from nearby forest fires.

Embodiments of the present invention may protect homes from nearby fire danger by spraying the home with a water umbrella. Corner mounted sprinklers on the roof may provide 360 degree coverage with water spray to protect the home and surrounding area from sparks, embers and fire.

As depicted in the figures, an embodiment may include a device 10 having base 20 that may be flat and round, possibly plastic or other durable material with watertight backing material on the bottom. The circumference of the base may be threaded and secured to the roof by screws, bolts or other securing mechanisms. Sprinkler head 14 may be attached to base 20. A coupling 22 may allow sprinkler head 14 to be attached to an external water hose 16. A sprinkler head that provides a directional stream or spray of water of varying degrees may be attached. Base 20 may have screw holes 24 and a gasket 26 between the base 20 and the roof 12.

In an embodiment, a cover 16 may be dome shaped, and made of the same hard material as base 20. Cover 16 may protect the device 10 when not in use by covering sprinkler head 14 and screwing or otherwise attaching to base 20.

An embodiment includes the watertight base and the sprinkler head. Other embodiments include the cover. Embodiments of the sprinkler head could be attached full time to a water source that might be regulated on and off by electronics, thereby eliminating the need to physically be present to attach a hose when the house 12 is in fire danger.

In another embodiment, the inside of the cover and the outside of the base may have three holes drilled in the bottom side of the cover and three matching threaded holes in the side of the base to allow the cover to attach to the base by means of set screws. Embodiments of an inlet may include a ¾″ female hose thread (FHT) polyvinyl chloride (PVC) swivel insertion, to allow easy attaching of a garden hose. Example embodiments of domes may be 8.75″ high or 4″ high. Embodiments may be referred to as the “fireshield rooftop home defender.”

In an embodiment, the base may secure the device to the roof of the home, may be attached to and may support the sprinkler head and may provide a means to attach a protective cover. The watertight backing may tightly seal the base to the roof so there is no leakage created by attaching the base to the roof with screws or other means that might otherwise compromise the weatherproofing integrity of the roof covering material. The sprinkler head may be attached to the base for stability. The device may provide a way to connect a water source, such as, but not limited to, outside water tap by means of a hose so that water can be regulated in such a way as to cover the roof of the house. The cover may protect the sprinkler head from outside elements, such as, but not limited to the weather, and screws onto the threaded base to create a fully enclosed dome shaped object.

An embodiment of a device may be attached to the roof of a home or other building, with one device on each of the four corners of the roof or some other configuration, as desired or necessary, to provide water coverage of the entire roof surface. When the house is in danger of fire from some nearby source, such as, but not limited to, a forest fire, the cover may be removed and a standard water hose can be attached from whatever source is nearby (primarily an outdoor water spigot or indoor water faucet with attachment capability). When the water is turned on, the sprinkler heads can be adjusted directionally (“directional”) so the spray or stream may compensate for factors that may affect complete water coverage of the roof, such as, but not limited to, the wind. The device could also be positioned from the roof to spray water around the outside circumference of the house thereby creating a defensible space against on-coming fire.

To make an embodiment, the base and cover could be of a molded material such as, but not limited to, plastic. The sprinkler head could be a commercially available head made of metal, plastic and other such materials.

To use an embodiment, a person could attach the device(s) to the roof of the house by a provided and/or recommended manner. When the house is perceived to be in danger of fire, the cover would be removed and an ordinary garden hose would be connected. Turning on the water supply and adjusting the water volume and spray would create a water envelope barrier on and around the building protecting it from wind carried embers, approaching fire or other fire danger.

Embodiments of the present invention may be self-installed on existing roofs as an add-on product and is only attached to water sources like an outdoor spigot when necessary, using an ordinary, inexpensive garden hose.

An embodiment of a device for a roof may include: a threaded, watertight base; a sprinkler head attached to the base; a coupling adapted to attach an external water hose to the sprinkler head; a securing mechanism adapted to attach the device to the roof; and a cover to protect the sprinkler head when the device is not in use.

I claim:

1. A sprinkler utilizing a roof and a water hose, comprising:
a base;
a sprinkler head attached to the base;
a coupling adapted to attach the water hose to the sprinkler head;
a securing mechanism adapted to attach the sprinkler to the roof; and
a cover to protect the sprinkler head when the sprinkler is not in use.

2. The sprinkler of claim 1, wherein the base has a watertight backing material.

3. The sprinkler of claim 1, wherein the circumference of the base is threaded to secure to the roof.

4. The sprinkler of claim 1, wherein the base is adapted to utilize screws or bolts to secure to the roof.

5. The sprinkler of claim 1, wherein the bottom side of the cover has three apertures; and the side of the base has three matching threaded holes to allow the cover to attach to the base by means of set screws.

6. The sprinkler of claim 1, wherein the sprinkler can be adjusted directionally to have a directional stream or spray of water of varying degrees.

7. The sprinkler of claim 1, wherein the sprinkler has a directional stream or spray of water of 360 degree coverage.

8. The sprinkler of claim 1, further comprising:
plurality of screw holes in the base; and
a gasket between the base and the roof that accommodates the screw holes.

9. The sprinkler of claim 1, wherein the cover is dome shaped.

10. The sprinkler of claim 1, further comprising:
electronics to regulate on and off of the water hose.

11. A sprinkler system, comprising:
a base having a watertight backing material, adapted to attach to a roof;
a sprinkler head attached to the base;
a coupling adapted to attach a water hose to the sprinkler head;
a securing mechanism adapted to attach the sprinkler to the roof; and
a cover to protect the sprinkler head when the sprinkler is not in use.

12. The sprinkler of claim 11, wherein the sprinkler can be adjusted directionally to have a directional stream or spray of water of varying degrees of 360 degree coverage.

13. A method of protecting a roof with a water hose, comprising:
providing a base;
attaching a sprinkler head to the base;
attaching a water hose to the sprinkler head;
securing the water hose to the sprinkler head utilizing a securing mechanism;
covering the sprinkler head with a cover when the sprinkler is not in use; and
uncovering the sprinkler head and utilizing the water hose to protect the roof.

14. The method of claim 13, wherein:
the base has a watertight backing material;
the sprinkler can be adjusted directionally to have a directional stream or spray of water of varying degrees; and
the sprinkler has a directional stream or spray of water of 360 degree coverage.
